(19) United States
(12) Patent Application Publication
(10) Pub. No.: US 2008/0265841 A1
(43) Pub. Date: Oct. 30, 2008

(54) Method of testing cycle life of lithium rechargeable battery

(76) Inventor: Cheonsoo Kim, Yongin-si (KR)

Correspondence Address: ROBERT E. BUSHNELL, 1522 K STREET NW, SUITE 300, WASHINGTON, DC, 20005-1202, US

(21) Appl. No.: 12/076,645

(22) Filed: Mar. 20, 2008

(30) Foreign Application Priority Data
Apr. 30, 2007 (KR) 10-2007-0041920

(51) Int. Cl. H02J 7/00

(52) U.S. Cl. 320/132

(57) ABSTRACT

The provided are two test methods for the cycle life test of a lithium rechargeable battery, which measures charge/discharge capacity by repeating charging and discharging lithium rechargeable battery. In one method, a constant current-constant voltage of charge rate of 1.5C and 4.2V, and a cut-off current of 0.1C are set to charge the battery, and a discharge rate of 1.0C and a cut-off voltage of 3.0V are set to discharge the battery, and there is no rest period between the charging and discharging. In another method, a constant current-constant voltage charge condition of charge rate of 1.0C and 4.2V, and a cut-off current of 0.1C are set to charge the battery, and a discharge rate of 1.3C and a cut-off voltage of 3.3V are set to discharge the battery, and there is no rest period between the charging and discharging. The present invention is appropriate to the cycle life test method of 500 cycles.

### CLAIM OF PRIORITY

This application makes reference to, incorporates the same herein, and claims all benefits accruing under 35 U.S.C. §119 from an application for METHOD OF TESTING CYCLE LIFE OF LITHIUM RECHARGEABLE BATTERY earlier filed in the Korean Intellectual Property Office on 30 Apr. 2007 and there duly assigned Serial No. 10-2007-0041920.

### BACKGROUND OF THE INVENTION

1. Field of the Invention

The present invention relates to a method of testing cycle life of lithium rechargeable battery, and more particularly to a method of testing cycle life of lithium rechargeable battery which reduces the time for measuring cycle life.

2. Description of the Related Art

In recent years, rechargeable batteries, which can be charged and discharged, are widely used in mobile electronic/electrical devices. In particular, high-capacity light-weight thin lithium rechargeable battery is being mostly used for lap-top computers, camcorders, mobile phones, and the like, which generally requires portability.

Generally, lithium ion rechargeable battery is composed of lithium metal oxide, which is capable of intercalation/deintercalation and used for positive electrode of a lithium rechargeable battery, carbon group active material, which is capable of intercalation/deintercalation and used for negative electrode, and non-aqueous electrolyte which is a path for lithium ions and is disposed between the positive and the negative electrodes.

Electrolyte reacts with impurities and lithium ions on the surface of the negative electrode, forming a solid electrolyte interface, even during a initial charging process. Through this reaction, electrolyte may be resolved and some of active materials may become inert. This chemical reaction is irreversible. The continuation of this reaction may cause reductions of internal resistance, the amount of the active materials, and cycle life. Therefore, the performance of battery will deteriorate with time.

Cycle life of battery may depends on an amount of reduction of the capacity of the battery, which is caused by repeats of charging and discharging, even if the battery has no fatal problem such as dendrite. To be commercialized, rechargeable battery has to satisfy a standard. For example, the battery's charge/discharge capacity may need to exceed 80% of the initial charge/discharge capacity after 300-cycle, or 50% of the initial charge/discharge capacity after 1000-cycle. The standard varies depending on the requirement from the manufacturing company or the customer. Therefore, to develop a new rechargeable battery or improve quality of the battery, there is a need to test the rechargeable battery to find whether its cycle life meets the standard set by customers or manufacturing companies.

As the usage of the battery depends on the user and environment, the battery is characterized in a standard test. One of the tests is a constant current-constant voltage (CCCV) test. A cycle of charging and discharging is repeated for a certain period, and a rest period is set between cycles.

Most of tests are performed by the reference of a charge rate or a discharge rate of 1 C (C-rate), which is an amount of current that charges or discharges the battery for an hour. If the battery reaches a predetermined condition, charging can be continued by changing constant current to constant voltage, or the charging may stop.

Because the cycle life test requires a number of charge/discharge procedures such as 300 cycles, 500 cycles, 1000 cycles, and the like, it may take several months to obtain the results. Therefore, the test may delay development of new products and the deadline for new test.

As electrochemical reaction may occur according to the respective charge/discharge condition of the battery, the cycle life also varies depending on the charge/discharge condition. For example, if charge/discharge condition is not suitable for electrochemical characteristics of the battery, cycle life and charge capacity are drastically reduced. And, if high voltage in which active materials and electrolyte is not capable of carrying out applied to the battery, irreversible reaction may occur, thereby reducing charge/discharge capacity. Rapid current also may cause unbalanced voltage.

When the over-charge current and over-charge voltage can be used to shorten the time needed for the charge/discharge test, it may damage the battery's electrochemical system. Therefore, it is impractical to test cycle life of the rechargeable battery by applying large amount of charge voltage and discharge voltage, because the cycle life of a battery in a normal usage may be accurately predicted by this method.

Accordingly, a reliable test method is not being suggested to reduce the time demanded for the test, as the charge/discharge capacity is deteriorating by the conventional cycle life test.

### SUMMARY OF THE INVENTION

The aspect of the present invention is to provide a cycle life test method for a lithium rechargeable battery which is capable of reducing the test time.

Another aspect of the present invention is to suggest a reliable cycle life test method for a lithium rechargeable battery, which is capable of reducing the test time, and has little deviation and high reliability.

For achieving the aspects of the present invention, one aspect of the cycle life test method of a lithium rechargeable battery is characterized in the step of charging the lithium rechargeable battery in a constant current-constant voltage condition, in which a charge rate is about 1.4 C to 1.6 C, a charge voltage is about 4.2 V, and a charge cut-off current is about 0.05 C to 0.15 C, and the step of having a first rest period after the step of charging, in which the first rest period is less than 10 minutes. The test method is further characterized in the step of discharging the lithium rechargeable battery, in which a discharge rate is about 1.0 C and a discharge cur-off voltage is about 3.0 V, and the step of having a second rest period after the step of discharging, in which the second rest period is less than 10 minutes. Each of the first rest period and the second period can be about zero minutes.

Another aspect of the cycle life test method of a lithium rechargeable battery is characterized in the step of discharging the lithium rechargeable battery, in which a discharge rate is about 1.2 C to 1.4 C and a discharge cur-off voltage is about 3.3 V to 3.55 V, and the step of having a second rest period after the step of discharging, in which the second rest period is less than 10 minutes. The test method is further characterized in the step of charging the lithium rechargeable battery in a constant current-constant voltage condition, in which a charge rate is about 1.0 C, a charge voltage is about 4.2 V, and a charge cut-off current is about 0.1 C, and the step of having a first rest period after the step of charging, in which the first rest period is less than 10 minutes. Each of the first rest period and the second period can be about zero minutes.

The test method of the present invention is appropriate to a cycle life test with more than 500 cycles of charge/discharge.

The above numerical range can be obtained by selecting an effective range of an optimum condition. The effective range is determined by a difference between two conditions that surround the optimum condition. For example, if a test is performed at conditions of 1.1, 1.3, 1.5, which increases by 0.2, and if an optimum condition is found at 1.3, an half of the difference between two conditions around the optimum condition is the effective range of the optimum condition. In this case, the effective range becomes 1.2 to 1.4. If there are more than two optimum conditions, the range that covers the two optimum conditions is taken as a numerical range.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a graph illustrating changes in voltage and current of a lithium rechargeable battery during charge/discharge period, when the lithium rechargeable battery is charged and discharged to test its cycle life.

FIG. 2 is a graph illustrating test results of the lithium rechargeable battery, which is tested in two different charge/discharge methods up to 400 cycles as comparative examples. The battery has an initial charge/discharge capacity of 600 mAh.

FIG. 3 is a graph illustrating test results of the lithium rechargeable battery, which is tested in two different charge/discharge methods up to 600 cycles as comparative examples. The battery has an initial charge/discharge capacity of 1250 mAh.

FIG. 4 is a table showing the two different charge/discharge conditions as described referring to the graphs of FIG. 3.

FIG. 5 is a graph showing charge/discharge capacity values obtained by charging/discharging same type lithium rechargeable batteries under different conditions by using various charge/discharge methods.

FIG. 6 is a table showing parameters for the various charge/discharge methods of FIG. 5.

FIG. 7 and FIG. 8 are dispersion graphs illustrating charge/discharge capacity and the required time for the tests of batteries, which are obtained under the different conditions of embodiments and comparative examples in cycle life test of 500 cycles as described referring to FIG. 5 and FIG. 6.

FIG. 9 is a table showing significant difference level (P-value) of the charge/discharge capacity of the test batteries, which are obtained under the different conditions shown in FIG. 6.

FIGS. 10a, 10b, and 10c are graphs comparing charge/discharge capacity distributions of the embodiments of the present invention.

FIG. 11 shows graphs illustrating changes of average charge/discharge capacity as a function of the charge/discharge parameters in the cycle life test of 300 cycles.

FIG. 12 shows graphs illustrating changes of average charge/discharge capacity as a function of the charge/discharge parameters in the cycle life test of 500 cycles.

### DETAILED DESCRIPTION OF THE INVENTION

Hereinafter, the present invention will be described in detail with reference to the accompanying drawings.

Main factors for the test method of cycle life include a charge rate, a charge voltage, a charge cut-off current, charge rest period, a discharge rate, a discharge cut-off voltage, discharge rest period.

As mentioned above, charge voltage, among the main factors, highly affects the generation of irreversible process in the electrochemical system of the rechargeable battery. Therefore, the change of the cycle life pattern due to changes of those factors is irregular rather than regular. Instead of focusing on the irregular factors, the method of the present invention focuses on the rest of the factors, which are not irregular, in order to reduce the test time.

The method of the present invention finds out a factor that highly affects the charge capacity based on test results, in particularly the test results of the cycle passage, and finds out another factor that does not affect the charge capacity and reduces the test time, while charge voltage is being kept in constant.

The test battery is charged and discharged under a regular charge/discharge condition at every 25^{th} cycle of charge/discharge, or at 50^{th}, 100^{th}, 300^{th}, or 500^{th} cycles of charge/discharge to draw the charge capacity. This method is aimed to find out whether the results of charge/discharge capacity obtained from the tests with the respective charge/discharge conditions are similar to the results obtained from the regular test.

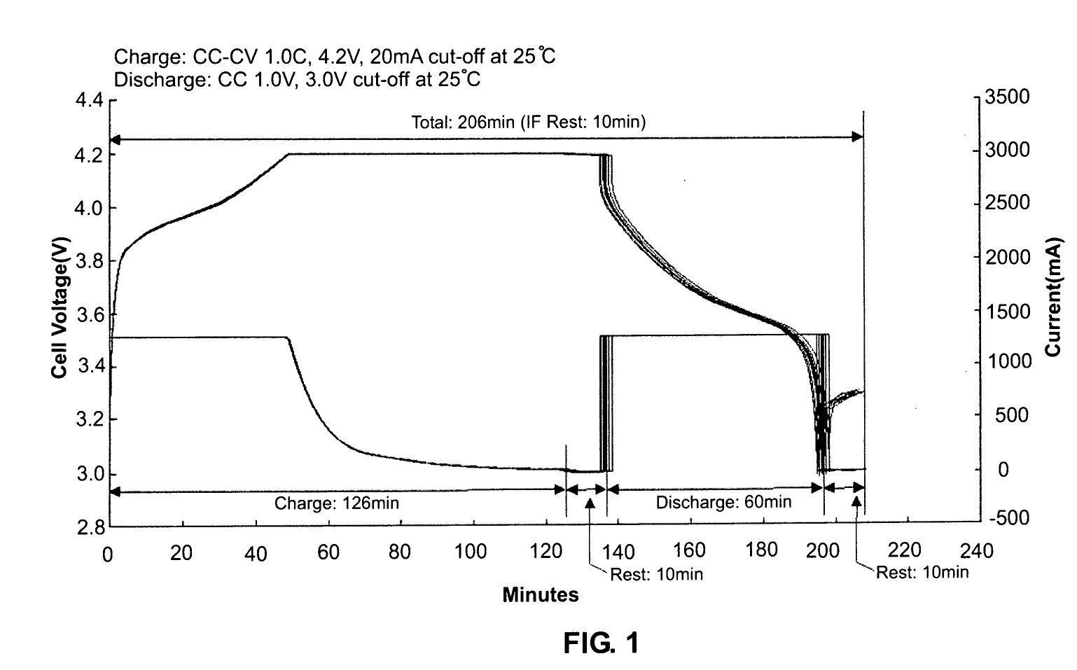

FIG. 1 shows changes of voltage and current of a lithium rechargeable battery during charge/discharge period. Several test results are drawn in the graph of FIG. 1. The battery is charged at a constant current-constant voltage of 4.2V, and current, voltage, and time can be the reference for charge cut-off. A battery is discharged at a discharge rate of 1 C and a cut-off discharge of 3V. After charging/discharging the battery, rest period of 10 minutes to 1 hour can stabilize the battery.

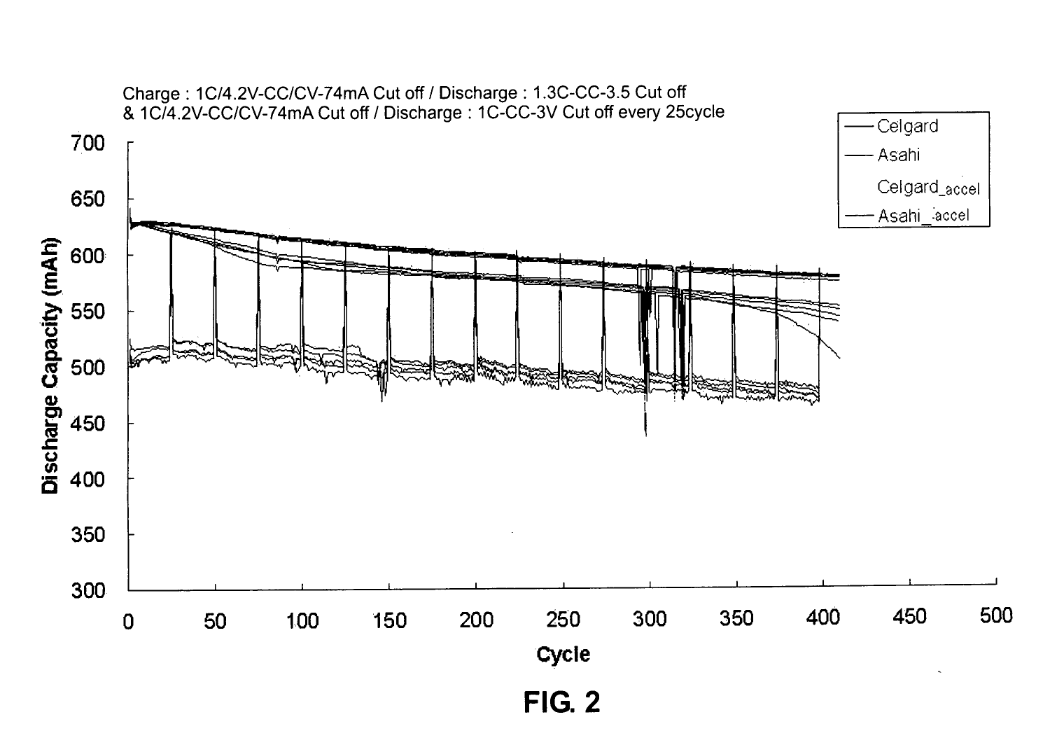

FIG. 2 is a graph showing results of cycle life test up to 400 cycles for the lithium rechargeable battery having average charge/discharge capacity of 600 mAh, while applying two different separators (Celgard and Asahi). This tested the cycle life under the regular charge/discharge condition and also tested the cycle life under the accelerated charge/discharge condition.

Two groups of lines at the top of the graph shows changing pattern of the charge/discharge capacity by a regular charge/discharge trial depending on the cycle. The regular charge/discharge is performed by applying a constant current-constant voltage (CCCV) charge condition of a charge rate of 1 C and a charging voltage of 4.2V, and a charge cut-off current of 74 mA, and applying a discharge rate of 1 C, a discharge cut-off voltage of 3V, and with 30 minutes rest period after both of the charging and discharging processes.

Two groups of lines at the bottom of the graph show changing pattern of the charge/discharge capacity depending on cycle under acceleration charge/discharge condition. The acceleration charge/discharge is performed at a discharge rate of 1.3 C, a discharge cut-off voltage of 3.5V while maintaining the charge condition. It is comparable with the results obtained from the regular charge/discharge as the charge/discharge capacity is measured by applying the regular charge/discharge condition at every 25^{th} cycle.

The groups applied with the accelerated charge/discharge condition shows similar pattern of charge/discharge capacity deterioration to that of the group applied the normal charge/discharge condition. But, there is a difference in the degree of deterioration, and the group applied with the accelerated charge/discharge condition shows the dispersion increasing with the number of cycles. Since such dispersion increase may undermine reliability of data, data having little dispersion is required to improve reliability.

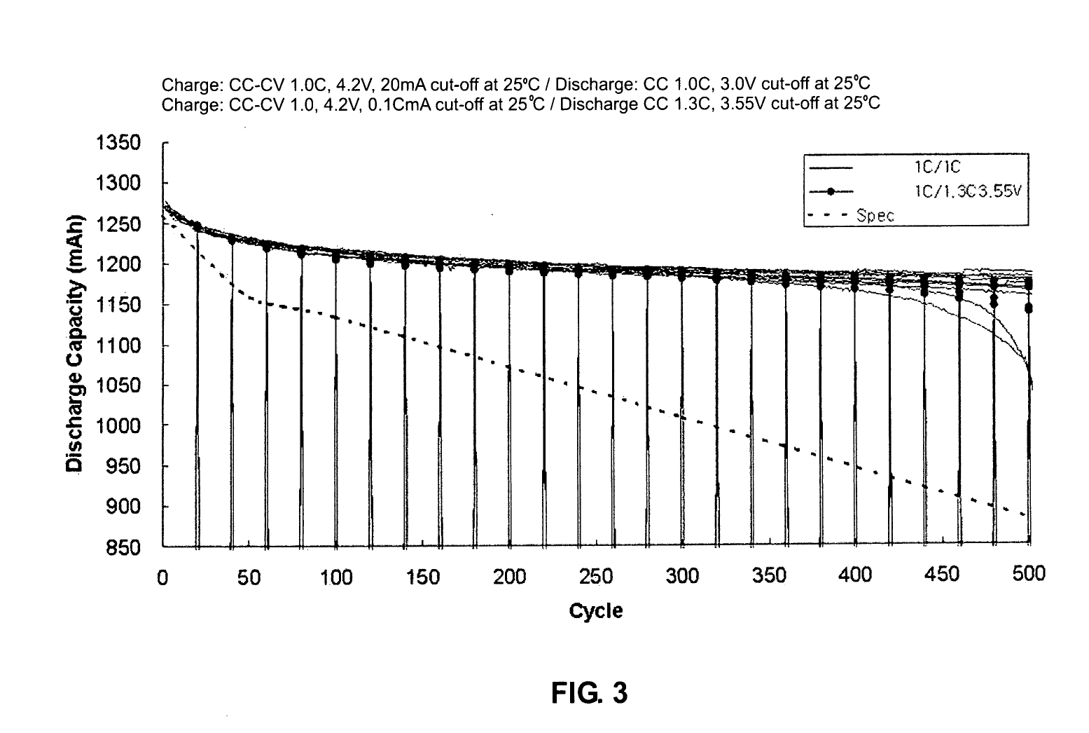

FIG. 3, as comparative examples, is a graph illustrating results of the cycle life test for a lithium rechargeable battery having initial charge/discharge capacity of 1250 mAh. This tested the cycle life under a first charge/discharge condition (1 C/1 C) and also tested the cycle life under a second charge/discharge condition (1 C/1.3 C, 3.55V).

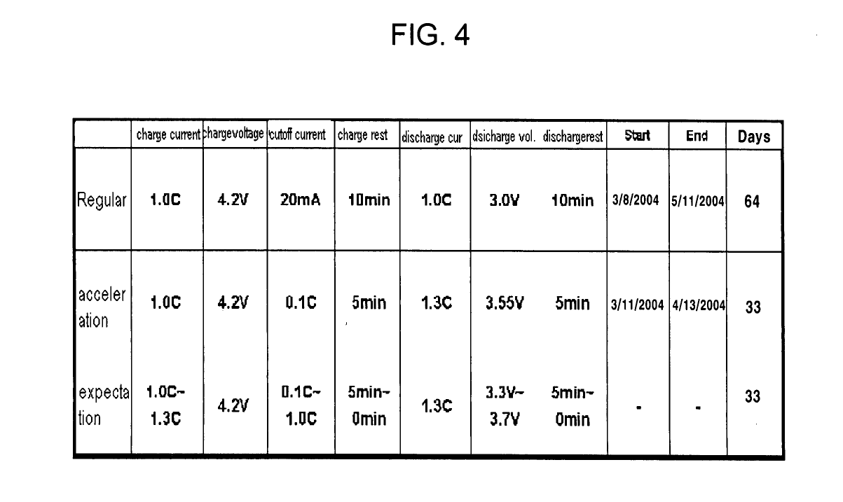

FIG. 4 is a table describing the first and the second charge/discharge conditions for the comparative examples of FIG. 3, and represents expected ranges of acceleration condition in order to draw the method of the present invention according to the comparison.

In the graph of FIG. 3, some batteries rapidly deteriorate in charge/discharge capacity under a first charge/discharge condition, but the graph as a whole shows little dispersion. After 350 cycles, the rechargeable battery applied with a second charge/discharge condition shows increasing dispersion of the charge/discharge capacity, but data as a whole are concentrated in a narrow range of dispersion. However, the graph of the charge/discharge capacity of the battery applied with the second condition does not show any dispersion, but only shows the peak value at every 25^{th} cycle.

The cycle life test conditions showed in FIG. 4 are as follows. A first condition is set with a charge rate of 1 C, a charge voltage of 4.2V, a charge cut-off current of 20 mA, a charge (or first) rest period of 10 minutes, a discharge rate of 1 C, a discharge cut-off voltage of 3V, a discharge (or second) rest period of 10 minutes, and 500 cycles as tested for 64 days. A second condition is set with a charge rate of 1 C, a charge voltage of 4.2V, a charge cut-off current of 0.1 C, a first rest period of 5 minutes, a discharge rate of 1.3 C, a discharge cut-off voltage of 3.55V, a second rest period of 5 minutes, and 500 cycles as tested for 33 days.

As described at the bottom row of FIG. 4, parameters may be roughly ranged under the acceleration condition in order to reduce the period needed for test through the graph of FIG. 3 and the table of FIG. 4.

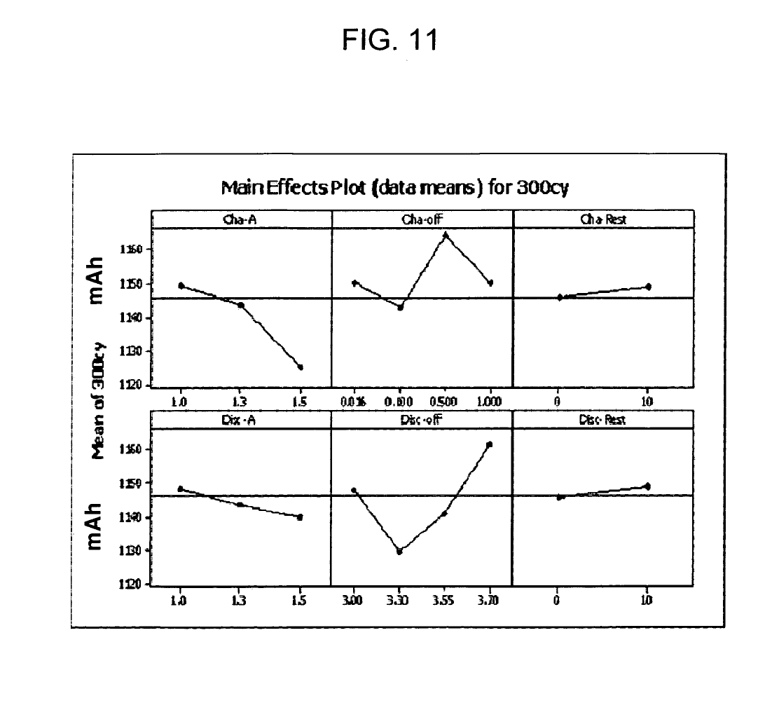

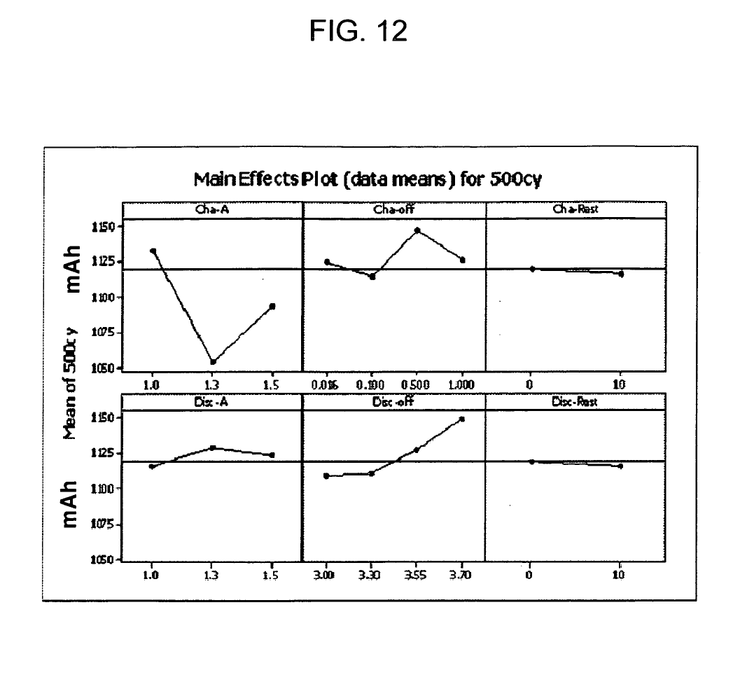

Roughly, when the magnitude of charge cut-off current, a discharge rate, and a discharge cut-off voltage increase, while the charge voltage is fixed, it is expected to reduce the time demanded for the test of cycle life. And, if the rest period after charge and discharge is reduced or eliminated, the time for the test of cycle life may be reduced. (This estimation can be verified with graphs of FIG. 11 and FIG. 12.)

However, if changes of these parameters make dispersion increase, or the degree of deterioration is sharply increased before completing the scheduled number of cycles, these conditions can not be taken to accelerate the cycle life test. On the contrary, when deterioration is so small that it shows results out of the existing pattern of the cycle life test, it can not be taken to accelerate the cycle life test.

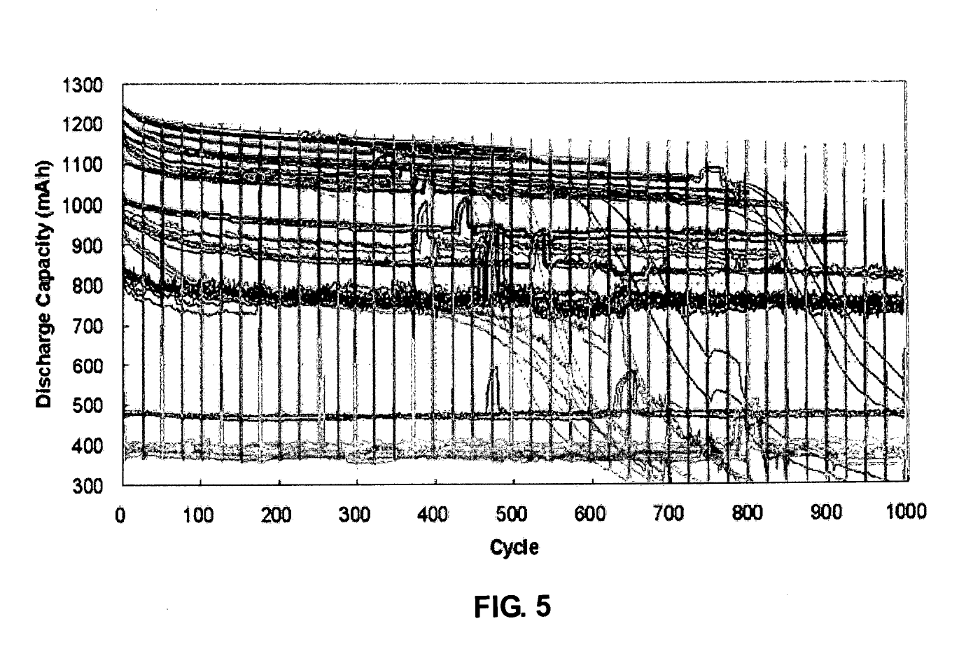

FIG. 5 is a graph of the cycle life test for a lithium rechargeable battery having regular charge/discharge capacity of 1250 mAh under the various charge/discharge methods. One group of 5 batteries is tested under each condition.

The dispersion of the graph resulted from testing each group under the different conditions can be indicator to verify the reliability of charge/discharge capacity results. The charge/discharge capacity results are obtained by applying regular charge/discharge condition at a specific cycle, for example at every 25^{th} cycle while applying a specific condition. The difference between those results and the charge/discharge capacity results of test batteries which are obtained from the cycle life test under the average charge/discharge condition may indicate that the specific charge/discharge conditions are appropriate to accelerate the cycle life test. For instance, the smaller the difference between the results from the test which was applied with regular charge/discharge condition at every 25^{th} cycle under the specific condition and the results from the test under the regular charge/discharge condition, the more the cycle life test reduces the time demanded for the cycle life test.

In FIG. 5, the peaks of the line except for every 25^{th} cycle is not caused by a problem of the test battery, but is caused by a problem of the charge/discharge condition. Therefore the peaks will not be considered.

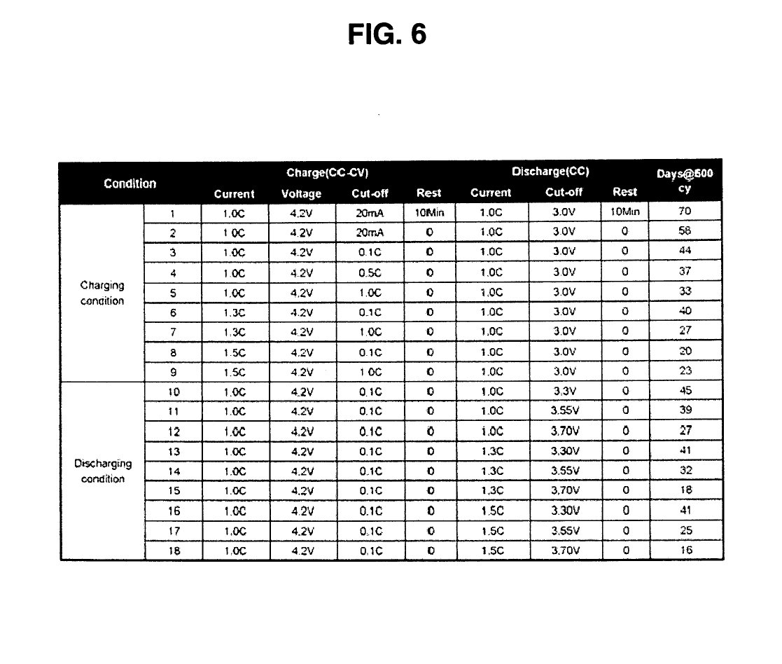

FIG. 6 is a table showing the charge/discharge conditions of the cycle life test which is similar to that in FIG. 5 and describes the time as days to complete 500 cycles under the respective conditions.

From Conditions 1 to 9 in the table are comparative examples and embodiments which are tested by changing charge parameters while maintaining fixed discharge parameters. From Conditions 10 to 18 are comparative examples and embodiments which are tested by maintaining fixed charge parameters while changing discharge parameters.

If a cycle life test under a certain condition has a difference in time with batteries of one group tested under the same condition, the condition itself may not be appropriate for the cycle life test. Therefore, a charge/discharge method under the condition is not preferable for cycle life test and may have low reliability.

The results of embodiments and comparative examples described in FIG. 6 are obtained by charging/discharging the lithium ion rechargeable battery having an average charge/discharge capacity of 1250 mAh under the respective embodiment and comparative example conditions, and by measuring charge/discharge capacity at every 25 cycles by charging/discharging the battery. The regular charge/discharge method is to charge/discharge the battery by applying a constant current-constant voltage (CCCV) condition with a charge rate of 1.0 C and 4.2V, a charge rest period of 30 minutes, a discharge rate of 1.0 C, a discharge cut-off voltage of 3.0 V, a discharge rest period of 30 minutes under normal temperature and pressure condition (at 25° C. and 1 atmosphere). The battery required 85 days for the cycle life test of 500 cycles in the regular charge/discharge method.

### EMBODIMENT 1

### Condition 8 of FIG. 6

20 days were required for the cycle life test of 500 cycle at a charge rate of 1.5 C, a charge cut-off current of 0.1 C, and no charge and discharge rest period in the regular charge/discharge method.

### COMPARATIVE EXAMPLE 1

### Condition 1 of FIG. 6

70 days were required for the cycle life test of 500 cycle under the condition of each 10 minutes rest period for charge and discharge. The comparative example serves as a reference for substituting for the regular charge/discharge method.

### COMPARATIVE EXAMPLE 2

### Condition 2 of FIG. 6

58 days were required for the cycle life test of 500 cycle with no charge and discharge rest period in the regular charge/discharge method.

### COMPARATIVE EXAMPLE 3

### Condition 3 of FIG. 6

44 days were required for the cycle life test of 500 cycle at a charge cut-off current of 0.1 C and no charge and discharge rest period in the regular charge/discharge method.

### COMPARATIVE EXAMPLE 4

### Condition 4 of FIG. 6

37 days were required for the cycle life test of 500 cycle at a charge cut-off current of 0.5 C and no charge and discharge rest period in the regular charge/discharge method.

### COMPARATIVE EXAMPLE 5

### Condition 5 of FIG. 6

33 days were required for the cycle life test of 500 cycle at a charge cut-off current of 1.0 C and no charge and discharge rest period in the regular charge/discharge method.

### COMPARATIVE EXAMPLE 6

### Condition 6 of FIG. 6

40 days were required for the cycle life test of 500 cycle at a charge current of 1.3 C, a charge cut-off current of 0.1 C, and no charge and discharge rest period in the regular charge/discharge method.

### COMPARATIVE EXAMPLE 7

### Condition 7 of FIG. 6

27 days were required for the cycle life test of 500 cycle at a charge current of 1.3 C, a charge cut-off current of 1.0 C, and no charge and discharge period in the regular charge/discharge method.

### COMPARATIVE EXAMPLE 8

### Condition 9 of FIG. 6

23 days were required for the cycle life test of 500 cycle at a charge current of 1.5 C, a charge cut-off current of 1.0 C, and no charge and discharge period in the regular charge/discharge method.

### EMBODIMENT 2

### Condition 13 of FIG. 6

41 days were required for the cycle life test of 500 cycle at a charge cut-off current of 0.1 C, a discharge rate of 1.3 C, a discharge cut-off voltage of 3.3V, and no charge and discharge rest period in the regular charge/discharge method.

### COMPARATIVE EXAMPLE 9

### Condition 10 of FIG. 6

45 days were required for the cycle life test of 500 cycle at a charge cut-off current of 0.1 C, a discharge cut-off voltage of 3.3V, and no charge and discharge period in the regular charge/discharge method.

### COMPARATIVE EXAMPLE 10

### Condition 11 of FIG. 6

39 days were required for the cycle life test of 500 cycle at a charge cut-off current of 0.1 C, a discharge cut-off voltage of 3.55V, and no charge and discharge period in the regular charge/discharge method.

### COMPARATIVE EXAMPLE 11

### Condition 12 of FIG. 6

27 days were required for the cycle life test of 500 cycle at a charge cut-off current of 0.1 C, a discharge cut-off voltage of 3.7V, and no charge and discharge period in the regular charge/discharge method.

### EMBODIMENT 3

### Condition 14 of FIG. 6

32 days were required for the cycle life test of 500 cycle at a charge cut-off current of 0.1 C, a discharge rate of 1.3 C, a discharge cut-off voltage of 3.55V, and no charge and discharge rest period in the regular charge/discharge method.

### COMPARATIVE EXAMPLE 12

### Condition 15 of FIG. 6

18 days were required for the cycle life test of 500 cycle at a charge cut-off current of 1.0 C, a discharge rate of 1.3 C, a discharge cut-off voltage of 3.7V, and no charge and discharge period in the regular charge/discharge method.

### COMPARATIVE EXAMPLE 13

### Condition 16 of FIG. 6

41 days were required for the cycle life test of 500 cycle at a charge cut-off current of 0.1 C, a discharge rate of 1.5 C, a discharge cut-off voltage of 3.3V, and no charge and discharge period in the regular charge/discharge method.

### COMPARATIVE EXAMPLE 14

### Condition 17 of FIG. 6

25 days were required for the cycle life test of 500 cycle at a charge cut-off current of 0.1 C, a discharge rate of 1.5 C, a discharge cut-off voltage of 3.55V, and no charge and discharge period in the regular charge/discharge method.

### COMPARATIVE EXAMPLE 15

### Condition 18 of FIG. 6

16 days were required for the cycle life test of 500 cycle at a charge cut-off current of 0.1 C, a discharge rate of 1.5 C, a discharge cut-off voltage of 3.7V, and no charge and discharge period in the regular charge/discharge method.

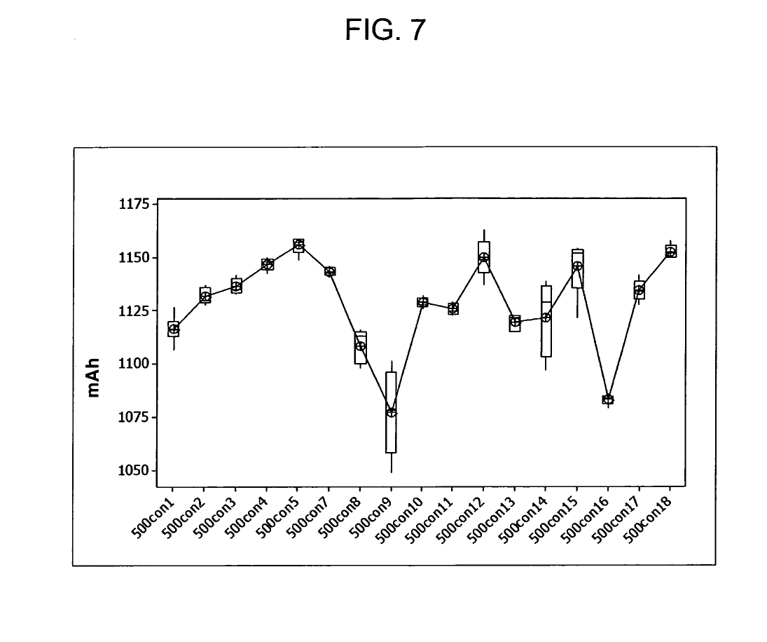

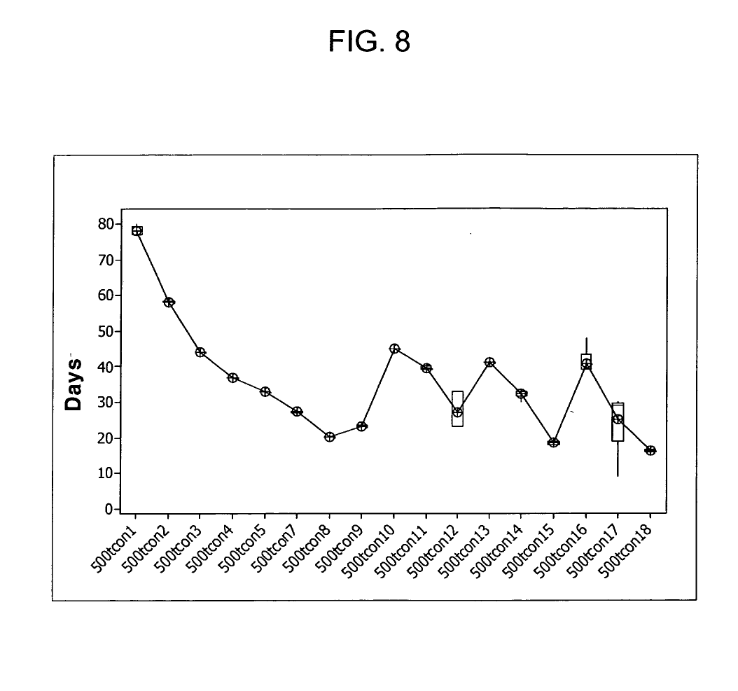

FIG. 7 and FIG. 8 are dispersion graphs describing charge/discharge capacity and the required time which are obtained from the cycle life test of 500 cycles under the respective embodiment and comparative example conditions. Because comparative example 6 (Condition 6) shows irregular wide dispersion, it is excluded in the cycle life test method that can be accelerated, and graphs for the rest of embodiments and comparative examples are shown in FIGS. 7 and 8.

Condition. 1 (comparative example 1), Condition 8 (embodiment 1), Condition 13 (embodiment 2), and Condition 14 (embodiment 3) of FIG. 7 show similar results to the charge/discharge capacity of 500 cycle in the regular charge/discharge method. Through them, the charge/discharge capacity of 500 cycles in the regular charge/discharge method may be obtained, and the time demanded for the cycle life test may be reduced. But, embodiment 3 (Condition 14) shows wide dispersion.

Except for Conditions 12 and 17, the rest of them in FIG. 8 show little dispersion of the required time which seems relatively reliable values. But, since the required time for the comparative example 1 (Condition 1) has little difference with that of the regular charge/discharge method, it may not reduce the period.

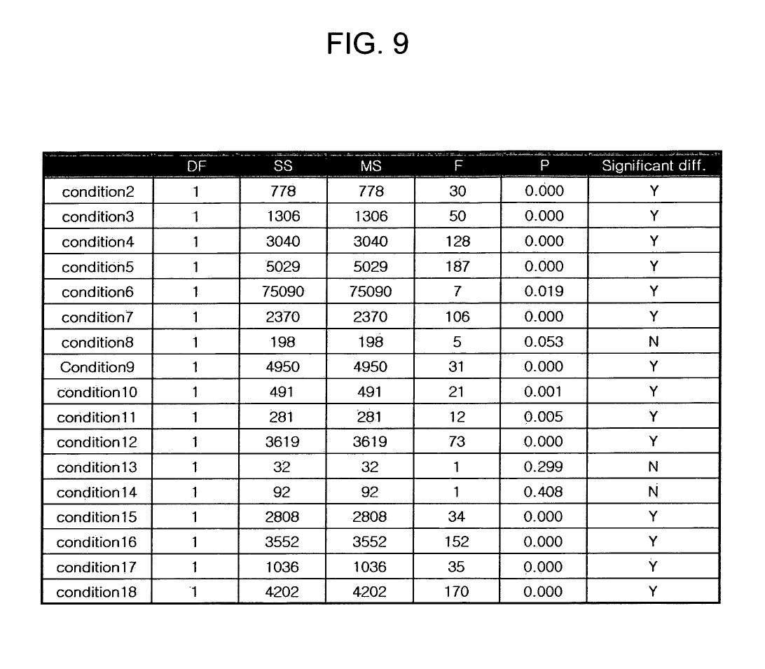

FIG. 9 shows P-value with significance level of 0.05 by using dispersion of results of the respective embodiment in the cycle life test of FIG. 5 like FIG. 7. P-value is the minimum significance level used in statistics to determine significance of results, so it will not be defined here.

Apart from comparative example 1 which serves as a reference, p-values of embodiment 1, 2, and 3 has no significant difference.

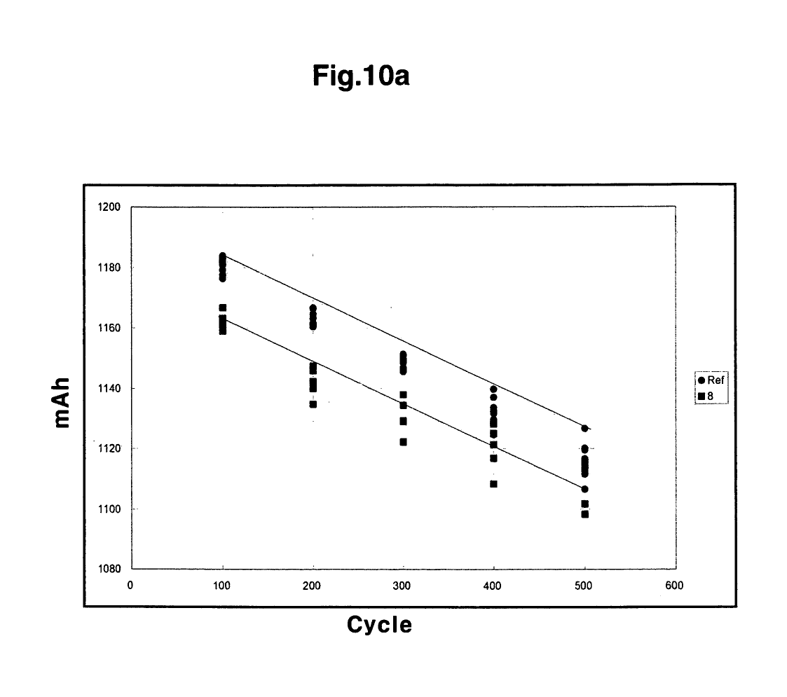

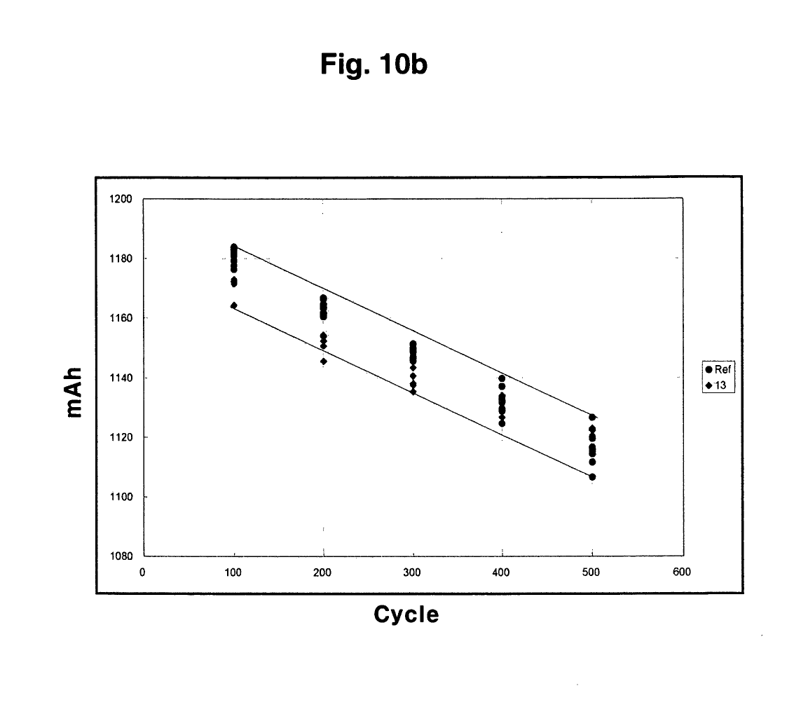

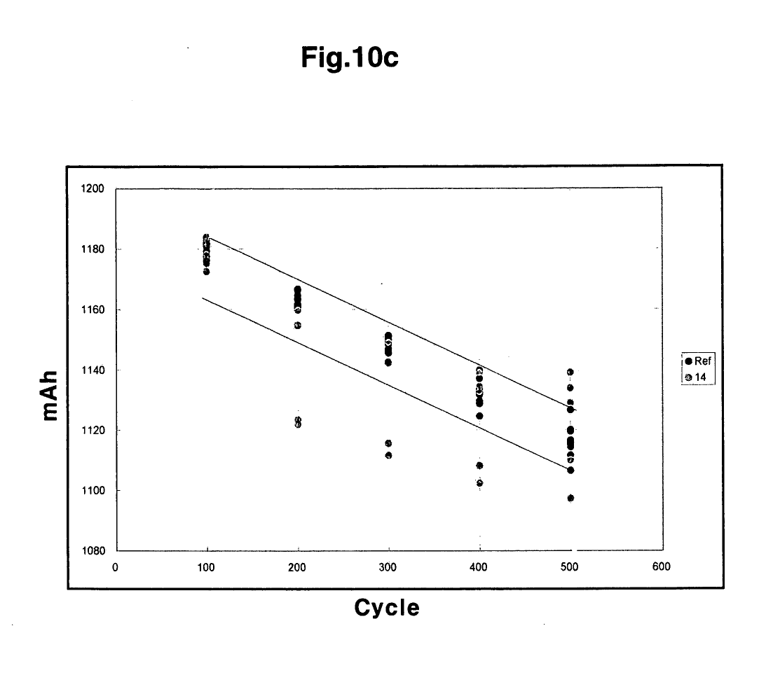

Graphs of FIGS. 10a, 10b, and 10c show dispersion data at every 100 cycles of embodiment 1, 2 and 3 which have no significant difference from among them in FIG. 9, and how the data is spaced apart from the reference.

Embodiment 3 of FIG. 10c shows that dispersion of charge/discharge capacity of respective batteries is becoming wider as the cycle numbers increases. Therefore, the embodiment is unfavorable. In contrast to this, the results of embodiment 1 of FIG. 10a show little dispersion compared with the reference, and the values below reference results are being regularly spaced apart from each other.

Particularly, the results of embodiment 2 of FIG. 10b show little dispersion compared to the reference and are distributed around the results. This embodiment may substitute the regular charge/discharge method and is an accelerated method to test cycle life.

Accordingly, in the present invention Conditions 8, 13, and 14 corresponding to embodiments 1, 2, and 3 are the conditions for an accelerated method for cycle life test, and Condition 13 of embodiment 2 is the most preferable condition.

FIGS. 11 and 12 are graphs to verify whether the limited ranges shown in FIG. 4 is appropriate for the tests for the conditions suggested in embodiments and comparative examples. FIGS. 11 and 12 show relationship between the test parameters and the results of charge/discharge capacity after 300 cycles and 500 cycles, respectively.

Three upper graphs of FIG. 11 are graphs for charge condition. From the left graph, charge parameters are a charge rate (Cha-A), a charge cut-off voltage (Cha-off), a charge rest period (Cha-Rest), respectively. The units of the x-axes (horizontal axes) of graphs from the left are C (C-rate), C (C-rate), minutes, respectively. The y-axis of the upper three graphs represents a charge capacity. As shown in the upper three graphs of FIG. 11, the charge rest period may not affect the charge/discharge capacity after 300 cycles, but charge rate and charge cut-off voltage considerably affect the charge/discharge capacity after 300 cycles. Therefore, charge rate and charge cut-off voltage may have to be appropriately applied to figure out conditions for the accelerated cycle life test method.

Three lower graphs of FIG. 11 are graphs for discharge condition. From the left graph, discharge parameters are a discharge rate (DISC-A), a discharge cut-off voltage (Disc-off), a discharge rest period (Disc-Rest), respectively. The units of the x-axes (horizontal axes) of graphs from the left are C, V (Volt), and minutes, respectively. The y-axis of the lower three graphs represents a discharge capacity. As shown in the lower three graphs of FIG. 11, the discharge rest period and discharge rate have little effect on the charge/discharge capacity (mean value) after 300 cycles, but discharge cut-off voltage considerably affect the charge/discharge capacity after 300 cycles. Therefore, discharge cut-off voltage may have to be appropriately applied to figure out conditions for the accelerated cycle life test method.

FIG. 12 shows a relationship between the test parameters and the charge/discharge capacity after 500 cycles. The charge/discharge capacity is a mean value after 500 cycles, and can be explained in the same manner as described referring to FIG. 11. As observed in the graphs of FIG. 11, charge rate and charge cut-off voltage considerably affect the charge/discharge capacity after 500 cycles, and discharge cut-off voltage considerably affects the charge/discharge capacity after 500 cycles.

As shown above, the selected main parameters in the present invention for the cycle life test method are appropriate. For example, as shown in the graphs of FIG. 12, eliminating charge/discharge rest period does not affect the results of 500 cycles, and help to reduce test time. It is more advantageous to set a charge rate 1.5 C rather than setting it 1.3 C to reduce changes in both of charge/discharge capacities and test time.

Since charge/discharge capacity measured according to the parameters in graphs is mean value, it shows a trend but does not determine specific parameter value. Accordingly, specific parameter values used in the present invention are determined after checking charge/discharge capacity depending under every condition.

According to the present invention, it has little deviation from the conventional test method and has high reliability, thereby reducing time required for the conventional cycle life test. It may reduce time required to develop new battery and also reduce cost and time for quality test.

What is claimed is:

1. A method of testing cycle life of a lithium rechargeable battery which measures charge/discharge capacity of the lithium rechargeable battery, comprising:
charging the lithium rechargeable battery in a constant current-constant voltage condition, a charge rate being about 1.4 C to 1.6 C, a charge voltage being about 4.2 V, a charge cut-off current ranging about 0.05 C to 0.15 C; and
having a first rest period after the step of charging, the first rest period being less than 10 minutes.

2. The method of testing cycle life of the lithium rechargeable battery as claimed in claim 1, wherein the first rest period is about zero minutes.

3. The method of testing cycle life of the lithium rechargeable battery as claimed in claim 1, further comprising:
discharging the lithium rechargeable battery, a discharge rate being about 1.0 C, a discharge cur-off voltage being about 3.0 V; and
having a second rest period after the step of discharging, the second rest period being less than 10 minutes.

4. The method of testing cycle life of the lithium rechargeable battery as claimed in claim 3, wherein the second rest period is about zero minutes.

5. The method of testing cycle life of lithium rechargeable battery as claimed in claim 1, wherein the steps of charging and discharging are repeated for 500 times.

6. The method of testing cycle life of lithium rechargeable battery as claimed in claim 3, wherein the steps of charging and discharging are repeated for 500 times.

7. A method of testing cycle life of a lithium rechargeable battery which measures charge/discharge capacity of battery, comprising:
discharging the lithium rechargeable battery, a discharge rate being about 1.2 C to 1.4 C, a discharge cur-off voltage being about 3.3 V to 3.55 V; and
having a second rest period after the step of discharging, the second rest period being less than 10 minutes.

8. The method of testing cycle life of the lithium rechargeable battery as claimed in claim 7, wherein the second rest period is about zero minutes.

9. The method of testing cycle life of the lithium rechargeable battery as claimed in claim 7, further comprising:
charging the lithium rechargeable battery in a constant current-constant voltage condition, a charge rate being about 1.0 C, a charge voltage being about 4.2 V, a charge cut-off current being about 0.1 C; and
having a first rest period after the step of charging, the first rest period being less than 10 minutes.

10. The method of testing cycle life of lithium rechargeable battery as claimed in claim 9, wherein the first rest period is about zero minutes.

11. The method of testing cycle life of the lithium rechargeable battery as claimed in claim 7, wherein the steps of charging and discharging are repeated for 500 times.

12. The method of testing cycle life of the lithium rechargeable battery as claimed in claim 8, wherein the steps of charging and discharging are repeated for 500 times.

13. The method of testing cycle life of the lithium rechargeable battery as claimed in claim 7, wherein the discharge cut-off voltage being about 3.3 V.
